(19) United States
(12) Patent Application Publication
(10) Pub. No.: US 2024/0210108 A1
(43) Pub. Date: Jun. 27, 2024

(54) METHODS AND SYSTEMS FOR PROCESSING RAW WOOD FIBER

(71) Applicant: Daizen Log-Tech Ltd., Kamloops (CA)

(72) Inventor: Yoshito ONA, Kamloops (CA)

(21) Appl. No.: 18/146,354

(22) Filed: Dec. 23, 2022

(51) Int. Cl. F26B 7/00; B27K 5/00; F26B 23/02

(52) U.S. Cl. CPC F26B 7/00; B27K 5/001; F26B 23/028; F26B 2210/16

(57) ABSTRACT

The present invention provides methods and systems for processing raw wood fiber to stabilize the shape and dimensions of the wood produced from the raw wood fiber following processing, by heating the raw wood fiber in a substantially oxygen-free atmosphere with combustion gas and super heated steam. The combustion gas is generated by burning a wood fiber-based fuel.

### FIELD OF INVENTION

The present invention relates to methods and systems for stabilizing the shape and dimensions of wood. In particular, the present invention relates to methods and systems for processing raw wood fiber to stabilize the shape and dimensions of wood products produced therefrom.

### BACKGROUND OF THE INVENTION

Trees have a complex cell structure that allows them to grow and stand as a single pole in the vertical direction. The cell structure is the result of the physical properties and interactions between natural polymers (for example, cellulose, hemi-cellulose and lignin) and water. These properties and interactions lead to various stresses within the tree structure. For example, as a tree grows in layers, tensile stress is generated from the bark-side of the tree and compressive stress occurs at the inner core or pith of the tree. Furthermore, trees may grow leaning in a particular direction, and in order to grow as a single, straight pole, compression increases on a lean side of the trunk and tension increases on an opposite side of the trunk. When a tree is logged and the resulting raw log is processed into wood products, these stresses and tensions are released, resulting in wood that deforms, cracks or twists during sawing and/or subsequent use.

Attempts have been made to generally stabilize the shape and dimensions of wood by drying the wood to remove water prior to processing into wood products. Various drying techniques have been developed, such as, for example, long-term natural drying methods, or mechanical drying methods that remove water while controlling the humidity and temperature of the processing chamber. Examples of mechanical drying methods include high temperature drying, low temperature dehumidification drying, radio frequency drying and vacuum drying. These methods remove water from the wood based on external heating by heat conduction. There are also internal heating methods for removing water from wood, such as microwave drying.

Although these methods remove water from the wood structure, none of them relieve the stress in wood that leads to deformation, cracking and twisting of wood products. By not removing and/or relieving the stress in wood, the wood will cup, twist and deform, such that as the wood is processed by milling into board, a straight cut results in a board not having a straight shape, as the stress within the wood was not released prior to milling. For example, certain species of tree, such as Western Red Cedar, Hemlock and Interior Douglas Fir, are viewed by persons of ordinary skill in the art as being hard or impossible to relieve the stress from within the wood using existing technologies. As a result, for building purposes which require large-dimensioned structural material, it is necessary to rely on engineered products such as laminated glulam beam, cross laminated timber and engineered wood in order to suppress the deformation of wood that occurs to wood products after the moisture removal treatments as described above.

Thus, there remains a need for methods of treating wood so as to improve dimensional stability for use in various applications.

### SUMMARY OF THE INVENTION

The present invention provides methods for maintaining and/or stabilizing the shape and dimensions of wood products by treating raw wood fiber so as to relieve or equalize the stresses within the wood, prior to sawing. As a result, deformation, cracking and/or twisting of the timber, lumber and/or boards produced from the wood fiber are significantly reduced, due to the release of stress within the wood prior to sawing. Furthermore, the wood products generated from the raw wood fiber processed according to the methods described herein may have improved anti-fungal and insect-repellant properties as compared to wood products obtained from wood fiber that does not undergo such processing.

Various aspects of the present disclosure provide methods, systems and apparatus for processing raw wood fiber to relieve or equalize stresses within the wood fiber. The embodiments disclosed herein are for methods and processes to dimensionally stabilize wood fiber.

In various aspects, the present invention provides a method of processing raw wood fiber to maintain and/or stabilize the shape and dimension of wood products produced therefrom, the method comprising: heating the raw wood fiber in a substantially oxygen-free atmosphere with combustion gas and superheated steam, wherein the combustion gas is generated by burning a biomass fuel, such as a wood fiber-based fuel.

The raw wood fiber may be from a wood source that grows bark and comprises a cambium layer. In various embodiments, the raw wood fiber may be a log. The log may include its bark. The wood fiber-based fuel may be waste fiber.

In various embodiments, a temperature of the raw wood fiber is heated to about 95° C.

In various embodiments, stresses in the raw wood fiber is normalized prior to sawing.

In various embodiments, unburned carbon is added to the raw log during the heating.

In various embodiments, the raw wood fiber has a moisture content of about 8% or greater, about 30% or greater, about 50% or greater, about 80% or greater or about 100% or greater, based on a weight of the raw wood fiber.

In various embodiments, the raw wood fiber has a moisture content between about 80% to about 200%, based on a weight of the raw wood fiber.

In various embodiments, the raw wood fiber has a lignin content between about 18% and about 35%, based on a weight of the raw wood fiber.

In various embodiments, the wood source undergoes secondary growth.

In various embodiments, the wood source may be a softwood.

In various embodiments, the wood source may be a hardwood.

In various embodiments, cellulosic microfibrils of the wood of the raw wood fiber recrystallize during the heating step.

In various embodiments, the heating step is performed prior to sawing the raw wood fiber into the one or more wood products.

In various aspects, the present invention provides a wood product produced from raw wood fiber processed according to a method as disclosed herein.

Other aspects and features of the present invention will become apparent to those of ordinary skill in the art upon review of the following description of specific embodiments of the invention in conjunction with the accompanying claims.

### BRIEF DESCRIPTION OF THE DRAWINGS

In drawings which illustrate embodiments of the disclosure,

FIG. 1 shows conversion of xylose, as a type of hemicellulose, to furan resin as occurs in wood during a method according to an embodiment of the invention.

FIG. 2 shows a picture of a cross-section of a Douglas Fir log that has not undergone treatment according to an embodiment of the methods as described herein (FIG. 2A) and a picture of a cross-section of a Douglas Fir log that has undergone treatment according to an embodiment of the methods as described herein (FIG. 2B).

### DETAILED DESCRIPTION

In the context of the present disclosure, various terms are used in accordance with what is understood to be the ordinary meaning of those terms.

Disclosed embodiments include systems, apparatus and methods associated with processing raw wood fiber in order to maintain and/or stabilize the shape and dimension of wood produced therefrom for further use as wood products. In various embodiments, the disclosed methods, apparatus and systems produce wood fiber that can be processed into wood products that have substantially reduced likelihood of warping, twisting or cracking as compared to wood products obtained from wood fiber that does not undergo similar processing. Furthermore, wood products produced from raw wood fiber processed according to the methods described herein may have more stable dimensions, increased specific strength, reduced deviation, improved surface properties, enhanced insect repellant properties, enhanced anti-fungal properties, or a combination thereof, compared to raw wood fiber that is not processed according to the methods described herein.

In various embodiments, raw wood fiber is positioned inside a processing apparatus. If the raw wood fiber is one or more logs, the one or more raw logs may include their bark. The processing apparatus includes a combustion furnace containing a wood fiber-based fuel and a treatment chamber for holding the raw wood fiber. Following ignition of the fuel, the temperature inside the treatment chamber is raised, for example, to about 120° C., which can be adjusted through adjustment of an air intake and/or exhaust gate. The combustion furnace may also comprise a steam generation pipe on a ceiling of the combustion furnace and the steam is introduced into the treatment chamber together with the combustion gas through a flue, and the raw wood fiber is heated conductively by external heating, superheated steam, and unburned carbon, as described below. The raw wood fiber is also heated internally by heat radiation, as described in more detail below.

The raw wood fiber is heated in a substantially oxygen-free or oxygen-free atmosphere with combustion gas and super-heated steam. The combustion gas is generated by burning a wood fiber-based fuel. Water molecules generated in the process of thermal decomposition generate superheated steam when the combustion temperature of the wood fiber-based fuel exceeds 100° C. Superheated steam has a heat radiant function when it exceeds 100° C. Further, when the temperature exceeds 170° C., the evaporation rate of water increases. Both of these characteristics promote internal heating of the raw wood fiber to release the tension and stress that exist in the raw wood fiber, more particularly between cellulose and hemi-cellulose that are bonded with lignin, as described in more detail below.

In various embodiments, the raw wood fiber is heated and the temperature of the wood gradually rises from the outer peripheral portion of the raw wood fiber, and when the temperature in the material begins to exceed 78° C., thermal softening of lignin and hemi-cellulose begins, under moisture non-equilibrium. In various embodiments, the raw wood fiber is heated evenly throughout the entire raw wood fiber.

Lignin is the polymer in wood that is mainly responsible for holding cellulose and hemi-cellulose together, and the cellulose and hemi-cellulose maintain the structure of the wood, both of which allow the tree to stand straight up as it grows. The methods disclosed herein release the stresses and strain in wood by softening lignin and hemicellulose. Lignin in wood has a heat softening point of about 134° C. to about 195° C. when the wood is dry, but this softening point reduces to about 78° C. to about 102° C. when the raw log is freshly harvested and has a high moisture content. The heat softening points of the main constituents of wood are shown in Table 1 below. The heat softening point of cellulose hardly changes when the wood is dried or wet, but the heat softening point of lignin and hemicellulose fluctuate greatly. Cellulose is a linear polymer that gathers together to form cellulose microfibrils in wood, which are composed of crystalline and amorphous portions. Furthermore, the cell walls of wood are arranged at various inclination angles with respect to the vertical fiber direction, and this state is solidified with lignin or hemicellulose to maintain constant strain to hold the tree upright. In various embodiments, the raw wood fiber may have a moisture content of about 8% or greater by weight, based on a weight of the raw wood fiber. For example, the raw wood fiber may have a moisture content of about 30% or greater by weight, based on a weight of the raw wood fiber. For example, the raw wood fiber may have a moisture content of about 50% or greater by weight, based on a weight of the raw wood fiber. For example, the raw wood fiber may have a moisture content of about 80% or greater by weight, based on a weight of the raw wood fiber. For example, the raw wood fiber may have a moisture content between about 80% by weight and about 200% by weight based on a weight of the raw wood fiber.

TABLE 1
Heat softening points of the main structural components of wood

| Structural component | When dry | When wet |
|---|---|---|
| Lignin | 134° C.~195° C. | 78° C.~102° C. |
| Hemicellulose | 181° C.~217° C. | 56° C.~142° C. |
| Cellulose | 231° C.~245° C. | 222° C.~239° C. |

Reference Goring, D.A.I. Pulp and Paper Mag. Canada, p. 64, (1963)

When the strain of cellulose microfibrils is relaxed by the thermal softening of lignin and hemicellulose, the cellulose molecules move more easily due to thermal vibrations, and, given that the methods disclosed herein are conducted in the substantial absence of oxygen such that the cellulose does not undergo any oxidation reactions, the cellulose microfibrils rearrange to favour the crystalline form. As a result, the wood structure becomes harder and the strength increases. The strength may be tested by measuring the deflection or pressure required to bend the treated wood fiber, as would be known by a person of ordinary skill in the art. For example, the extreme bending stress of the treated wood fiber is improved in various embodiments. In various embodiments, raw wood fiber from a softwood may have bending characteristics more similar to a hardwood following treatment according to a process as described herein.

The evaporation of water from the raw wood fiber creates a moisture imbalance in the wood fiber but the lignin and hemicellulose soften to release the stresses in the wood. As the raw wood fiber is heated in the treatment chamber, water travels through the wood fiber and evaporates from one of the ends of the wood fiber. The water inside the raw wood fiber expands thermally, causing turgor pressure in the raw wood fiber which pushes the water in the wood out of the ends. The high thermal conductivity of water in the wood with a high water content also efficiently raises the temperature of the wood to about 95° C. Furthermore, repeated expansion and contraction of the wood promotes the discharge of water from the ends of the raw wood fiber, thereby creating water channel(s) which may increase the efficiency of water extraction from the wood.

The combustion gas generated by the combustion of the wood fiber-based fuel contains pyrolysis products and thermal energy, generated in the combustion process of cellulose, hemi-cellulose and lignin. This combustion process consumes oxygen in the atmosphere of the processing apparatus. In the process, when the wood-based fuel burns, the organic matter having a low ignition point burns first, and carbonization starts on the remaining combustion surface. Since carbon produced by carbonization has a high ignition point, the temperature of the combustion chamber temporarily drops until this temperature is reached. When the ignition point of carbon is reached, the temperature rises again, and this temperature transfers heat to the fuel below, igniting the organic matter in this part. The temperature of the combustion furnace fluctuates periodically due to the continuation of this repetition. This temperature fluctuation results in thermal vibration and is transmitted to the raw wood fiber.

The thermal vibration causes molecules within the wood of the raw wood fiber to move, thereby promoting thermal softening of lignin, which in turn contributes to the release of stresses within the wood of the raw wood fiber.

Unburned carbon (or soot) generated in the process of thermal decomposition of the wood fiber-based fuel generates radiant heat as a blackbody. Due to this heat radiation function, the water in the wood generates heat due to thermal vibration, and the wood is efficiently heated from the inside. The amount of blackbody radiant heat reaches 960 kcal in 1 hour per 1 m², when the ambient temperature is 100° C. This unburned carbon is introduced into the treatment chamber together with the combustion gas and superheated steam, and adheres to the wall surface of the treatment chamber and the surface of the raw wood fiber, becoming a blackbody radiant heat source and efficiently heating the raw wood fiber from the inside. For an internal surface area of 100 m² and temperature of 100° C., the radiant heat generated by the blackbody is 96,000 kcal, the calorific value of which is 1 kg of wood fiber-based fuel is 2,700 kcal, which is equivalent to burning 35.5 kg of wood per hour.

During this period, thermal softening is promoted by this thermal vibration, which is a characteristic of combustion gas, and as the temperature in the raw wood fiber rises, the internal stress begins to disperse or be released. In embodiments where the raw wood fiber is one or more raw logs with their bark, the raw logs are fixed by the exodermis (bark), the internal stress is not released but rather is dispersed so as to be uniform throughout the wood.

During processing, substitution reactions occur within the wood of the raw wood fiber to change hydrophilic groups (—OH) to hydrophobic groups (—OR), together with resignification (polymerization) by polycondensation reactions of low molecular weight compounds, resignification of hemicellulose by dehydration reactions, and resignification of cellulose. These reactions may be caused by thermal softening of lignin and hemicellulose. In various embodiments, the shape and dimensions of the wood of the raw wood fiber are maintained, stabilized and/or improved by recrystallization of the cellulose microfibrils of the wood that occurs during the heating via the foregoing reactions.

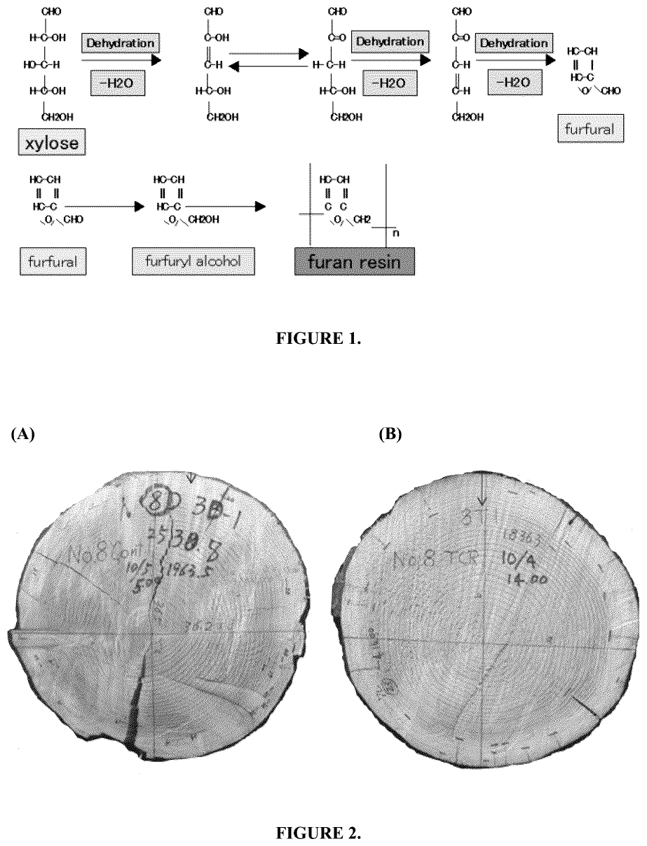

More specifically, taking advantage of the property that the heat softening point drops when the raw wood fiber is wet, the hemicellulose molecules move more easily when the temperature of the raw wood fiber is raised to 95° C. in a reducing atmosphere. A series of dehydration reactions occur due to heat, and in the case of xylose, which is a type of hemicellulose, it converts to a furan resin as shown in FIG. 1. When lignin exists in a tree, it acts as an adhesive that hold cellulose and hemicellulose, and at the same time, it plays an important role of storing water in the wood tissue and keeping the tissue supple. However, its strong affinity with water molecules is an obstacle to the use of wood.

In a reducing atmosphere, the presence of heat causes a self-assembling reaction to occur to form furan resin. Furan resin is partially hydrophobic due to the substitution of hydroxyl groups that easily form hydrogen bonds with water. As a result, the equilibrium water content of the wood after the thermochemical reduction treatment is lowered, which contributes to the stabilization of shape and/or dimensions of the wood.

In various embodiments, wood products produced from the raw wood fiber processed according to the methods described herein prior to sawing can be stored for longer periods of time with limited stress checking and cracking, compared to wood products produced from raw wood fiber that is not processed according to the methods described herein prior to sawing.

As shown in FIG. 2, a cross-section of a Douglas Fir log that had not undergone treatment according to the processes and methods as described herein is shown (FIG. 2A), with substantial cracking occurring during storage. FIG. 2B shows a cross-section of a Douglas Fir log that has undergone processing according to an embodiment of the methods as described herein, and no significant cracking is observed. Thus, treatment of raw wood fiber to relieve stresses and tension within the fiber by a combination of thermochemical reduction to release internal tension and extraction of moisture from the raw wood fiber, results in a wood product with increased dimensional stability, amongst other properties.

In various embodiments, a processing apparatus for carrying out the methods described herein may comprise a treatment chamber for holding the raw wood fiber. The apparatus may comprise a combustion chamber for burning the wood fiber-based fuel, to which air is added, that is adjacent to the treatment chamber and extends laterally into the treatment chamber. The treatment chamber may comprise a flue, a suction port and a smoke exhaust port, and automatic or manual control valves may be included with this ports. Water also evaporates from the raw wood fiber as it dries, and this water is extracted from inside the treatment chamber to outside. In various embodiments, a dual chamber may be used, with a concrete wood burning chamber (combustion chamber) and an insulated stainless steel chamber as the treatment chamber. Carriage for loading and unloading the wood fiber may be a common rail system.

As used herein, the term “about” refers to an approximately +/−10% variation from a given value. It is to be understood that such a variation is always included in any given value provided herein, whether or not it is specifically referred to. The use of the word “a” or “an” when used herein in conjunction with the term “comprising” may mean “one,” but it is also consistent with the meaning of “one or more,” “at least one” and “one or more than one.”

Citation of references herein is not an admission that such references are prior art to the present invention.

The present invention has been described with regard to one or more embodiments. However, it will be apparent to persons skilled in the art that a number of variations and modifications can be made without departing from the scope of the invention as defined in the claims. Such modifications include the substitution of known equivalents for any aspect of the invention in order to achieve the same result in substantially the same way. Numeric ranges are inclusive of the numbers defining the range. The scope of the claims should not be limited by the preferred embodiments set forth in the examples, but should be given the broadest interpretation consistent with the description as a whole.

What is claimed is:

1. A method of processing raw wood fiber to stabilize the shape and dimension of one or more wood products produced therefrom, the method comprising:
heating the raw wood fiber in a substantially oxygen-free atmosphere with combustion gas and superheated steam, wherein the combustion gas is generated by burning a wood fiber-based fuel.

2. The method according to claim 1, wherein the raw wood fiber is from a wood source that grows bark and comprises a cambium layer.

3. The method according to claim 1, wherein a temperature of the raw wood fiber is heated to about 95° C.

4. The method according to claim 1, wherein unburned carbon is added to the raw log during the heating.

5. The method according to claim 1, wherein the raw wood fiber is one or more raw logs.

6. The method according to claim 5, wherein the one or more raw logs include their bark.

7. The method according to claim 1, wherein the raw wood fiber has a moisture content of about 8% or greater, based on a weight of the raw wood fiber.

8. The method according to claim 1, wherein the raw wood fiber has a moisture content of about 30% or greater, based on a weight of the raw wood fiber.

9. The method according to claim 1, wherein the raw wood fiber has a moisture content of about 50% or greater, based on a weight of the raw wood fiber.

10. The method according to claim 1, wherein the raw wood fiber has a moisture content of about 80% or greater, based on a weight of the raw wood fiber.

11. The method according to claim 1, wherein the raw wood fiber has a moisture content between about 80% and about 200%, based on a weight of the raw wood fiber.

12. The method according to claim 1, wherein the raw wood fiber has a lignin content between about 18% and about 35%.

13. The method according to claim 1, wherein the wood source undergoes secondary growth.

14. The method according to claim 1, wherein the wood source is a softwood.

15. The method according to claim 1, wherein the wood source is a hardwood.

16. The method according to claim 1, wherein cellulosic microfibrils of the wood of the raw wood fiber recrystallize during the heating step.

17. The method according to claim 1, wherein the heating step is performed prior to sawing the raw wood fiber into the one or more wood products.

18. A wood product produced from a raw log processed according to the method of claim 1.
